(19) United States
(12) Patent Application Publication
(10) Pub. No.: US 2021/0179106 A1
(43) Pub. Date: Jun. 17, 2021

(54) SYSTEM AND METHOD FOR CONTROLLING OPERATION OF AUTONOMOUS VEHICLE

(71) Applicants: Hyundai Motor Company, Seoul (KR); Kia Motors Corporation, Seoul (KR)

(72) Inventor: In-Su Kim, Anyang (KR)

(73) Assignees: Hyundai Motor Company, Seoul (KR); Kia Motors Corporation, Seoul (KR)

(21) Appl. No.: 16/868,276

(22) Filed: May 6, 2020

(30) Foreign Application Priority Data
Dec. 16, 2019 (KR) 10-2019-0167660

(51) Int. Cl. B60W 30/17; B60W 30/16; B60W 30/18; B60W 40/04; B60W 60/00; B60W 10/18

(52) U.S. Cl. CPC B60W 30/17; B60W 30/162; B60W 30/18127; B60W 2556/50; B60W 40/04; B60W 60/0018; B60W 10/18; B60W 30/18159

(57) ABSTRACT

A system and a method for controlling an operation of an autonomous vehicle are provided, in which information regarding front vehicles and surrounding traffic information is received in the autonomous vehicle. A traffic flow of the front vehicles and a time when a traffic light color is changed are estimated through the input information and a maximum vehicle velocity at which the autonomous vehicle is capable of crossing the traffic light is calculated while securing a safety distance from the front vehicle by regenerative braking force to generate an acceleration/deceleration control signal for adjusting a driving velocity. Braking is performed by distributing regenerative braking force and friction braking force of the driving vehicle according to the acceleration/deceleration control signal.

### CROSS-REFERENCE TO RELATED APPLICATIONS

This application claims priority under 35 U.S.C.§ 119 to Korean Patent Application No. 10-2019-0167660, filed on Dec. 16, 2019, the disclosure of which is incorporated herein by reference in its entirety.

### BACKGROUND

### 1. Field of the Disclosure

The present disclosure relates to a system and a method for controlling an operation of an autonomous vehicle, and more particularly, to a system and a method for controlling regenerative braking to be maximized and friction braking to be minimized by predicting a time when braking is preemptively required in passing through a traffic light by considering information regarding various vehicles in front of a driving vehicle.

### 2. Description of the Related Art

An autonomous vehicle refers to a vehicle which may be driven autonomously to a set destination by collecting external information, determining a surrounding traffic condition, and establishing a driving plan without an operation of a driver. The autonomous vehicle is a transportation device fused with state-of-the-art technologies such as advanced sensors configured to detect objects while the vehicle is being driven, network communications that exchange information mutually, artificial intelligence control systems configured to receive various collected data and process and determine the received various data in real time, and the like.

Information which is generated on a road toward a driving destination, such as traffic information, road construction, traffic accident information, etc., in addition to map information is received and processed in real time. Furthermore, a technology of a form which mutually exchanges information with surrounding vehicles has also been developed. When the information is used, the driver may stably operate the vehicle by preemptively determining a danger of the vehicle rather than driving the vehicle.

In recent years, companies have actively developed technology with an interest in autonomous vehicle. The autonomous vehicle should take an appropriate action by detecting and determining various driving conditions and among various driving conditions, the traffic light at an intersection is one of important driving conditions which are common.

In this regard, according to a traffic accident status information, the number of traffic accidents which occur in an interaction zone in 2007 accounts for the largest proportion, approximately 47% of the total traffic accidents. Accordingly, it is important to implement safety to be guaranteed when the autonomous vehicle is driven at the intersection and a plan to reduce a proportion of the traffic accident through such implementation is required.

Meanwhile a developed technique provides a cruise control method for enhancing fuel efficiency in which a driving velocity for fuel efficiency is determined based ona time when the traffic light is changed to a red color according to information such as a traffic signal information status (e.g., red/green/yellow signal), a distance of a vehicle ahead, etc., a starting is turned off for enhancing the fuel efficiency, and regenerative braking and friction braking operations are determined.

As another developed technique provides a braking method of an autonomous vehicle in which the vehicle is operates at a comfortable deceleration at the beginning according to traffic signal information (e.g., red signal), the vehicle are operated at an automatic emergency braking deceleration when additional braking is required, and traffic signal information and image information of a signal camera are compared to confirm reliability.

Yet another developed technique provides a method operating a regenerative braking optimum deceleration in which the regenerative braking is maximally operated from vehicle velocity and distance information of a front vehicle to operate the vehicle at a deceleration and a vehicle velocity capable of decelerating the vehicle without the friction braking.

According to the related art, a brake is operates so that the regenerative braking becomes the maximum from the status (e.g., red/green/yellow) of the traffic light, the velocity of the front vehicle, and a distance between the vehicle and the front vehicle. In other words, a braking time is determined based on a distance from a vehicle in front of the driving vehicle, a traffic light color (e.g., red/green/yellow), and a time when the traffic signal color is changed. Accordingly, in the related art, since only information of a vehicle (i.e., a first front vehicle) immediately in front of the vehicle is used, when there is a substantial distance between the vehicle and the first front vehicle, the vehicle may be driven at a high velocity. However, the first front vehicle may be suddenly decelerated according to driving conditions of several vehicles (i.e., a second front vehicle, a third front vehicle, a fourth front vehicle, etc.) preceding the first front vehicle and in this case, the vehicle following the rear of the first front vehicle is suddenly decelerated at a greater deceleration.

Accordingly, a safe driving method is required, which reduces the velocity and performs the deceleration by preemptively operating the regenerative braking by previously recognizing behaviors of several vehicles in front of the vehicle instead of one vehicle in front of the vehicle. In other words, a safe driving method is required which prevents dangerous situations such as a case where sudden braking of operating even the friction braking in an emergency situation or a case where the vehicle stops in the middle of the intersection as the traffic light turns red at the time when the vehicle is located in the middle of the traffic light intersection in bumper-to-bumper traffic, etc.

### SUMMARY

The present disclosure provides a technology considering information regarding a first vehicle (i.e., a first front vehicle) positioned in a traffic light and in front of the vehicle and various information regarding various vehicles (i.e., a second front vehicle, a third front vehicle, a fourth front vehicle, etc. as surrounding vehicles) preceding thereto and enhance fuel efficiency by minimizing friction braking (e.g., sudden braking) and maximizing regenerative braking.

The present disclosure has been made in an effort to solve a problem in which a vehicle stops at an intersection in a traffic light red section due to bumper-to-bumper traffic (e.g., vehicle delay) by detecting a maximum vehicle velocity for each section, a regenerative braking amount, a flow of front vehicles, etc., in advance as a defensive driving technology of preventing a collision through braking by operating only the regenerative braking by predicting a time when braking is preemptively required when the vehicle passes through the traffic light. In other words, the present disclosure presents a method for controlling a vehicle velocity and a braking time to reduce an accident risk of an autonomous vehicle.

An exemplary embodiment of the present disclosure a system for controlling an operation of an autonomous vehicle may include: an information input unit configured to receive information regarding front vehicles of a driving vehicle and surrounding traffic information; an autonomous controller configured to estimate a flow of the front vehicles and a time when a traffic light color is changed from a signal received from the information input unit and calculate a maximum vehicle velocity at which the driving vehicle is capable of crossing the traffic light while securing a safety distance from the front vehicle only by regenerative braking force to generate an acceleration/deceleration control signal for adjusting a driving velocity; and a braking unit configured to perform braking by distributing regenerative braking force and friction braking force of the driving vehicle according to the acceleration/deceleration control signal received from the autonomous controller.

The information input unit may be configured to receive information using at least one of Internet Of Things (IOT), Vehicle-to-Vehicle (V2V), a radar, a LiDAR, an ultrasonic sensor, a camera, and a navigation. The autonomous controller may be configured to collect information regarding front vehicles driven on the same traffic lane as the driving vehicle from the information input unit to determine a vehicle delay phenomenon. Additionally, the autonomous controller maybe configured to collect information regarding front vehicles driven on the same traffic lane as the driving vehicle from information regarding the IOT in the traffic light to determine the vehicle delay. The braking unit may be configured to calculate a deceleration based on the maximum vehicle velocity by considering total braking force of the regenerative braking force and the friction braking force to distribute the regenerative braking force and the friction braking force of the driving vehicle.

Another exemplary embodiment of the present disclosure provides a method for controlling an operation of an autonomous vehicle that may include: receiving information regarding front vehicles and surrounding traffic information in the autonomous vehicle; estimating a flow of the front vehicles and a time when a traffic light color is changed through the input information and calculating a maximum vehicle velocity at which the driving vehicle is capable of crossing the traffic light while securing a safety distance from the front vehicle only by regenerative braking force to generate an acceleration/deceleration control signal for adjusting a driving velocity; and performing braking by distributing regenerative braking force and friction braking force of the driving vehicle according to the acceleration/deceleration control signal.

In the receiving of the information, information may be received using at least one of Internet Of Things (IOT), Vehicle-to-Vehicle (V2V), a radar, a LiDAR, an ultrasonic sensor, a camera, and a navigation of the autonomous vehicle. In the generating of the acceleration/deceleration control signal, information regarding front vehicles driven on the same traffic lane as the driving vehicle may be collected from the input information to determine the vehicle delay phenomenon. Additionally, in the generating of the acceleration/deceleration control signal, information regarding front vehicles driven on the same traffic lane as the driving vehicle may be collected from the IOT information on the traffic light to determine the vehicle delay phenomenon. In the performing of the braking, a deceleration according to the maximum vehicle velocity may be calculated by considering total braking force of the regenerative braking force and the friction braking force to distribute the regenerative braking force and the friction braking force of the driving vehicle.

According to an exemplary embodiment of the present disclosure, a vehicle maybe preemptively decelerated in a regenerative braking section by estimating bumper-to-bumper (e.g., vehicle delay) of various front vehicles in advance, i.e., regenerative braking is maximized and friction braking (e.g., sudden braking) is minimized to enhance fuel efficiency. According to an exemplary embodiment of the present disclosure, the vehicle is safely braked without sudden braking to prevent a collision and safely drive the vehicle.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a block diagram illustrating an entire system configuration including an autonomous vehicle and front vehicles according to an exemplary embodiment of the present disclosure;

FIG. 2 is a schematic view illustrating a system architecture of an autonomous vehicle according to an exemplary embodiment of the present disclosure;

FIG. 3 is a block diagram for defining a term representing a relationship between an autonomous vehicle and a surrounding traffic condition according to an exemplary embodiment of the present disclosure;

FIG. 4 is a flowchart showing a method for controlling an operation of an autonomous vehicle according to an exemplary embodiment of the present disclosure;

FIG. 5 is a schematic view for describing a method for discriminating front vehicles on the same traffic lane according to an exemplary embodiment of the present disclosure;

FIG. 6 is a graph showing a vehicle velocity and braking force distribution depending on a distance from a first front vehicle when a braking force distribution strategy in the related art is applied; and

FIG. 7 is a graph showing a vehicle velocity and braking force distribution depending on a distance from a first front vehicle when a braking force distribution strategy according to an exemplary embodiment of the present disclosure is applied.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/controller refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present disclosure will be described in detail with reference to contents disclosed in the accompanying drawings. However, the present disclosure is not restricted or limited by exemplary embodiments. Like reference numerals presented in each drawing refer to elements that perform substantially the same functions.

Objects and effects of the present disclosure may be naturally appreciated or clearer by the following description and the objects and effects of the present disclosure are not limited only by the following disclosure. Further, in describing the present disclosure, a detailed description of known technologies associated with the present disclosure may be omitted when it is determined that the detailed description may unnecessarily obscure the subject matter of the present disclosure.

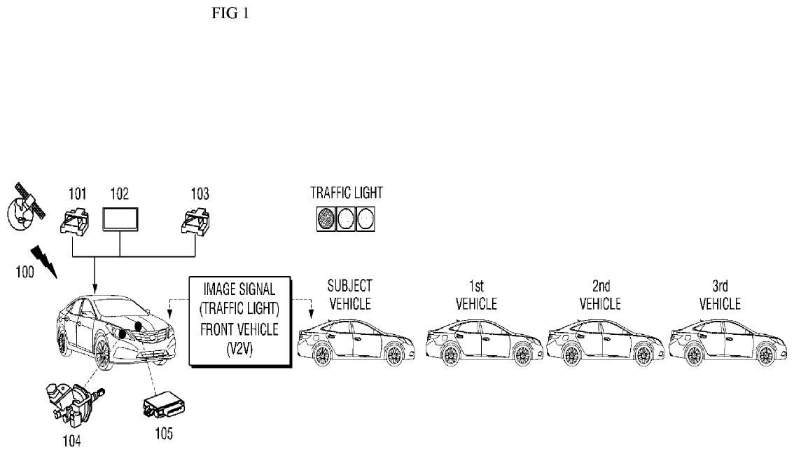

FIG. 1 is a block diagram illustrating an entire system configuration including an autonomous vehicle and front vehicles according to an exemplary embodiment of the present disclosure. As illustrated in FIG. 1, an autonomous vehicle (e.g., the subject or traveling vehicle) uses IOT/V2V (e.g., inter-vehicle communication technology) 100, a camera 101 (or other imaging device), a navigation 102, a radar/LiDAR sensor 103, an ultrasonic sensor, etc., to collect information of various vehicles (e.g., surrounding vehicles including 1^{st} vehicle, 2^{nd} vehicle, 3^{rd} vehicle, etc.) located in front of the subject vehicle.

An autonomous controller 105 of the autonomous vehicle (e.g., the vehicle, the subject or traveling vehicle) may prevent the autonomous vehicle from stopping at a crosswalk in a section in which a traffic light has a red color by determining motions of various surrounding vehicles (e.g., 1^{st} vehicle, 2^{nd} vehicle, 3^{rd} vehicle, etc.) being driven in front of the autonomous vehicle in advance from information collected in real time. Further, a brake electronic controller (ECU) 104 of the autonomous vehicle may be configured to perform braking by distributing regenerative braking force and friction braking force according to a braking time and a braking demand deceleration.

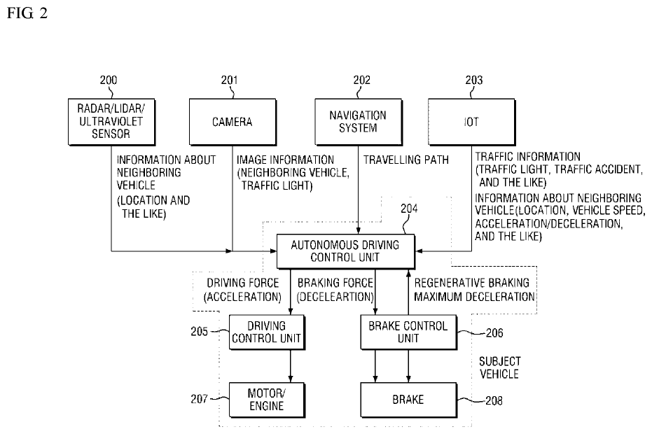

FIG. 2 is a schematic view illustrating a system architecture of an autonomous vehicle according to an exemplary embodiment of the present disclosure. Referring to FIG. 2, an autonomous vehicle according to an exemplary embodiment of the present disclosure is constituted by an information input unit including a radar/LiDAR/ultrasonic sensor 200, a camera 201, a navigation 202, and IOT/V2V 203, a braking unit including an autonomous controller 204, a brake controller 206, and a brake 208, and a driving unit including a driving controller 205 and a motor/engine 207.

The information input units 200, 201, 202, and 203 configured to receive information regarding front vehicles of a driving vehicle and a surrounding environment may be configured to transmit and receive various information to and from the outside while driving using network communications and sensors mounted on the vehicle. The IOT/V2V 203 as the information input unit may be configure to receive map information, traffic information (e.g., a traffic light, road construction, a traffic accident, etc.) up to a driving destination, front vehicle information (e.g., a location, a vehicle velocity, whether braking/acceleration is performed, deceleration/deceleration, etc.), surrounding vehicle information, etc., using a wireless network.

In this regard, a connected vehicle may be configured to transmit and receive various information to and from the outside bi-directionally connected via the wireless network inside/outside the vehicle using the IOT and the V2V while the vehicle is being driven and a connected vehicle adopting IT information and communication technology may be driven while transmitting and receiving various vehicle data. Traffic information according to a traffic lane, a predicted traffic amount for each time zone, an optimal route, a location of the vehicle, a location of a counter vehicle, a destination, etc., may be shared in real time using the data and various information including a vehicle warning light, a vehicle condition, a traffic system, and the like may also be shared. The connected vehicle technology is already commercialized and in the present disclosure, by using the technology, when each vehicle is connected to the network, required data may be transmitted/received vehicle to vehicle.

The vehicle sensor as another information input unit may include various sensors recognizing objects mounted on the vehicle, e.g., the radar/LiDAR/ultrasonic sensor 200, the camera 201, etc., and may be configured to detect a location, the velocity, and the deceleration/acceleration of the front vehicle and a traffic light color (e.g., green/yellow/red) using the sensors. In particular, the radar/LiDAR/ultrasonic sensor 200 may be configured to detect the front vehicle information such as the location and transfer the detected front vehicle information to the autonomous controller 204 and the camera 201 may be configured to detect image information such as the front vehicle and the traffic light and transfer the recognized image information to the autonomous controller 204.

The autonomous controller 204 configured to determine whether the vehicle may cross on the traffic light only by the regenerative braking by estimating the flow of the front vehicle may be configured to receive the traffic light color and a time when the traffic light color is changed by input signals from the information input units 200, 201, 202, and 203 and estimate whether the vehicle may cross on the traffic light before the traffic light is changed from a green signal to a red signal from driving statuses of the front vehicles and a distance between the vehicle and the traffic light (e.g., no congestion). The driving velocity may be adjusted by the autonomous controller 204 through the estimation and in this case, a braking force (e.g., deceleration) control command may be transferred to the braking units 206 and 208 and a driving force (e.g., acceleration) control command may be transferred to the driving units 205 and 207. Further, the autonomous controller 204 may be configured to determine whether bumper-to-bumper (e.g., vehicle delay) based on traffic congestion or a front vehicle accident is made considering driving velocity of the front vehicles, whether the front vehicles decelerate, etc., and calculate a maximum vehicle velocity at which the vehicle may be safely driven only by the regenerative braking force and this will be described below in detail.

The braking units 206 and 208 may be configured to perform braking according to a distribution strategy of the regenerative braking force and the friction braking force of a current vehicle and an operation slope of the friction braking force based on maximum regenerative braking force and a current brake condition (e.g., actuator performance deterioration) may be predicted based on a battery charging state in the brake controller (e.g., brake ECU) 206 which is the braking unit. Further, the brake controller 206 may be configured to calculate the maximum vehicle velocity and deceleration by considering total brake force of the regenerative braking force and the friction braking force and calculate the maximum vehicle velocity and deceleration capable of driving the vehicle only by the regenerative braking force and transfer the calculated maximum vehicle velocity and decelerations to the autonomous controller 204.

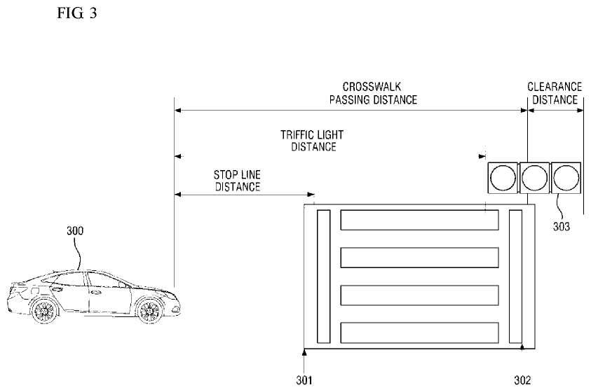

FIG. 3 is a block diagram for defining a term representing a relationship between an autonomous vehicle and a surrounding traffic condition according to an exemplary embodiment of the present disclosure. As illustrated in FIG. 3, hereinafter, a distance up to a crosswalk start point 301 from the vehicle 300 may be referred to as a “stop line distance”, a distance up to a crosswalk end point 302 from the vehicle 300 may be referred to as a “crosswalk passing distance”, a distance up to a traffic light 303 from the vehicle 300 may be referred to as a “traffic light distance”, and a predetermined interval for securing a safety distance between the vehicle 300 and the first front vehicle may be referred to as a “clearance distance”.

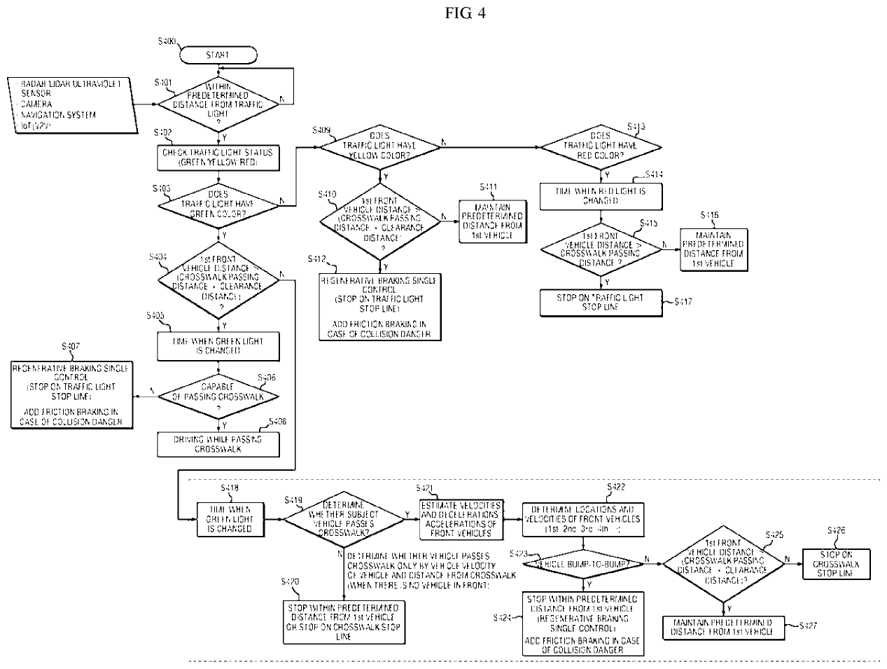

FIG. 4 is a flowchart showing a method for executing an operation of an autonomous vehicle according to an exemplary embodiment of the present disclosure and when a control logic according to the flowchart is appropriately described, a time of changing the traffic light to the green color to the red color may be acquired through the input information using the IOT, etc., vehicle velocities of front vehicles (several vehicles) may be calculated from the input information using the IOT and the camera, and whether the vehicle may pass through the intersection may be estimated while maintaining a predetermined safety distance (e.g., interval) between the vehicle and the front vehicle.

In response to estimating that the front vehicle may not cross the intersection according to vehicle velocity reduction or low-velocity driving of the front vehicle from the IOT, the image information, and the input information using the sensor mounted on the vehicle or the vehicle may not pass the intersection while maintaining the safety distance with the front vehicle even though the front vehicle passes the intersection, the velocity may be reduced by braking or decelerating the vehicle only by the regenerative braking in advance to allow the vehicle to stop on the stop line before reaching the traffic light. Therefore, friction braking may be minimized to enhance the fuel efficiency. Hereinafter, each step on the flowchart of FIG. 4 will be described in detail. Notably, the method described herein below may be executed by a controller.

First, in step S401, whether the traffic light is positioned from the vehicle within a predetermined distance may be determined using the radar/LiDAR/ultrasonic sensor, the camera, the navigation IOT/V2V, etc., and in response to determining that the traffic light is not positioned within the predetermined distance, the process may return to the start point (step S400) again and in response to determining that the traffic light is positioned within the predetermined distance, the process may proceed to step S402 to check the traffic light status (green/yellow/red).

Further, whether the traffic light has the green color may be determined in step S403 and in response to determining that the traffic light does not have the green color, the process may proceed to step S409 and whether the traffic light has the yellow color may be determined and in response to determining that the traffic light does not have the yellow color, the process may proceed to step S413 and whether the traffic light has the red color may be determined. In response to determining that the traffic light has the red color in step S413, the process may proceed to step S414 and the time when the red light is changed may be estimated.

Whether the distance between the vehicle and the first front vehicle is greater than the crosswalk passing distance of the vehicle may be determined in step S415 according to the time estimated in step S414 and in response to determining that the distance is greater than the crosswalk passing distance, the vehicle may be stopped on a traffic light stop line (step S417). In response to determining that the distance is less than the crosswalk passing distance, the vehicle may be stopped with a predetermined distance from the first front vehicle (step S416).

In response to determining that the traffic light has the yellow color in step S409, the process may proceed to step S410 and whether the distance between the vehicle and the first front vehicle is greater than the sum of the crosswalk passing distance of the vehicle and the clearance distance may be determined. In response to determining that the distance is greater than the sum, the vehicle may be stopped on the traffic light stop line by performing regenerative braking single control and friction braking may be added at the time of a collision danger (step S412) and in response to determining that the distance is less than the sum, the vehicle may be maintained ata predetermined distance from the first front vehicle (step S411).

Meanwhile, in response to determining that the traffic light has the green color in step S403, the process may proceed to step S404 and whether the distance between the vehicle and the first front vehicle is greater than the sum of the crosswalk passing distance of the vehicle and the clearance distance may be determined. In response to determining that the distance is greater than the sum, i.e., in response to determining that there is a margin of a clearance to allow the first front vehicle to pass the crosswalk based on the vehicle and even the vehicle to pass the crosswalk, the process may proceed to step S405 to estimate the time when the green light is changed.

Additionally, whether the vehicle may pass the crosswalk may be estimated in step S406 according to the time estimated in step S405 and when the first front vehicle is driven by passing the traffic light crosswalk based on the vehicle, whether the vehicle may pass the traffic light may be estimated using Equation 1 below by considering a distance d from the vehicle to the traffic light, a vehicle velocity v, and a time t when the traffic light is changed from the green color to the yellow color.

Equation 1

wherein, d: a distance between the vehicle and the traffic light, v: a vehicle velocity, t: a time (period) when the traffic light is changed from the green color to the yellow color.

When based on Equation 1 above, a d′ value is greater than a predetermined value, and as a result, it is estimated that the vehicle may pass the crosswalk, the vehicle may becontinuously driven by passing the crosswalk without braking (step S408). When the d′ value is less than the predetermined value, and as a result, it is estimated that the vehicle may not pass the crosswalk, the braking unit may be configured to receive a single regenerative braking deceleration to decelerate the vehicle at the time when the vehicle may stop on the traffic light stop line only by the regenerative braking. However, when an emergency situation (e.g., a collision danger, etc.) occurs while decelerating by the regenerative braking as described above, the friction braking may be additionally performed to perform sudden braking (step S407).

In response to determining that the distance between the vehicle and the first front vehicle is less than the sum of the crosswalk passing distance of the vehicle and the clearance distance in step S404, the process may proceed to step S418 to estimate the time when the green light is changed. Whether the vehicle may pass the crosswalk in step S419 may be determined according to the time estimated in step S418 and in this case, when there is no vehicle in front, whether the vehicle may pass the crosswalk only may be determined by the vehicle velocity and the crosswalk passing distance of the vehicle. In response to determining that the vehicle may not pass the crosswalk in step S419, the vehicle may be stopped with a predetermined distance from the first front vehicle or stops on the crosswalk stop line (step S420) and in response to determining that the vehicle may pass the crosswalk in step S419, the velocities and the decelerations/accelerations of the front vehicles may be estimated (step S421).

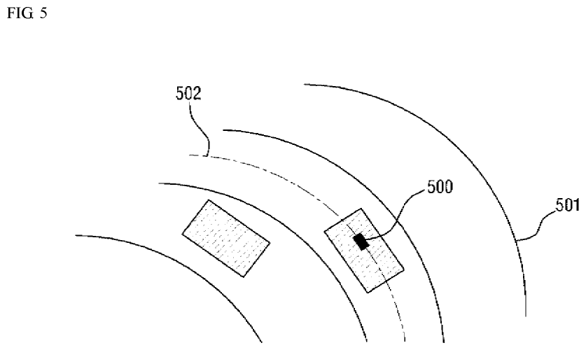

The locations and the velocities of the front vehicles (1^{st}, 2^{nd}, 3^{rd}, 4^{th}, . . . ) may be determined in step S422 according to the value estimated in step S421 and the process may proceed to step S423 to estimate whether a vehicle bumper-to-bumper scenario (e.g., vehicle delay) is present. To estimate a bumper-to-bumper (e.g., vehicle delay) scenario of the front vehicles which are driven on the same traffic lane as the vehicle on a route on which the autonomous vehicle is driven, it may first be discriminated which vehicle among several vehicles around the vehicle is a vehicle in front of the vehicle and then various information for estimating bumper-to-bumper is collected for the corresponding vehicle. A method for checking a traffic lane on which the vehicle is driven among several traffic lanes of the road on which the vehicle is driven and discriminating vehicles on the same traffic lane while being in front of a driving route of the vehicle among the vehicles around the vehicle will be described below in detail in association with FIG. 5.

In response to determining that the vehicle bumper-to-bumper scenario is present in step S423, the process may proceed to step S424 to allow the vehicle to stop with a predetermined distance from the first front vehicle through the regenerative braking single control and add the friction braking at the time of the collision danger. Further, in response to determining that the vehicle bumper-to-bumper scenario is not present in step S423, the process may proceed to step S425. Whether the distance between the vehicle and the first front vehicle is greater than the sum of the crosswalk passing distance of the vehicle and the clearance distance may be determined and in response to determining that the distance is greater than the sum, the vehicle may be operated to maintain a predetermined distance from the first front vehicle (step S427) and in response to determining that the distance is less than the sum, the vehicle may be stopped on the traffic light stop line (step S426).

Discriminating the bumper-to-bumper scenario from information of several vehicles in front among logics of FIG. 4 is a characteristic part of the present disclosure different from the conventional technology and this will be described in more detail in association with FIG. 4. First, in response to determining that the traffic light is the green light in step S403 and that there is a margin of a safety distance interval between the vehicle and the first front vehicle in step S404, a time when the green light may be changed to the yellow light is collected using the IOT, etc. and whether the vehicle may pass the crosswalk from the velocity of the vehicle, an interval up to the crosswalk passing distance, etc. (in this case, when there is no vehicle in front, it is determined whether the vehicle may pass the crosswalk only by the vehicle velocity of the vehicle and the distance up to the crosswalk) may be determined (steps S418 and S419). In particular, when there is the margin of the safety distance between the vehicle and the first front vehicle and a current vehicle velocity of the vehicle is sufficient, whether the vehicle may pass the crosswalk may be determined by checking an interval up to the crosswalk passing distance or the first front vehicle and the vehicle velocity of the first front vehicle.

Meanwhile, when the traffic light has the yellow color or the red color (steps S409 and S413), the vehicle may begin to stop by decelerating while maintaining the interval from the first front vehicle by the regenerative braking without passing the crosswalk (step S412, S416, and S417). In response to verifying that the vehicle may not pass the crosswalk due to a time when the traffic light is changed from the green color to the yellow color is insufficient since the velocity of the vehicle is low or the distance up to the crosswalk is substantial or the safety distance interval from the first front vehicle is minimal or the first front vehicle is decelerated in step S419, the vehicle may be stopped while maintaining the safety distance from the first front vehicle or stops on the crosswalk stop line (step S420).

However, in response to determining that the vehicle may pass the crosswalk in step S419, whether the vehicle may not maintain the safety distance due to the driving velocities of the front vehicles are low (i.e., vehicle delay) may be determined from the information (steps S421 and S422) of the front vehicles such as the second front vehicle, the third front vehicle, the fourth front vehicle, etc., based on the vehicle (step S423). Accordingly, the bumper-to-bumper (e.g., vehicle delay) information may be checked in step S423 and this is a method may distinguish a vehicle delay phenomenon from the information of the front vehicles (i.e., the first front vehicle, the second front vehicle, the third front vehicle, the fourth front vehicle, etc.) on the same traffic lane.

In other words, the method for checking the vehicle delay may include monitoring conditions of the vehicles within a distance range by encapsulating the clearance distance in the crosswalk passing distance. For example, when the fourth front vehicle is not present within a crosswalk passing distance range (including the clearance), the information regarding only up to the third front vehicle may be collected and the information includes whether a brake deceleration may be performed, the acceleration/deceleration, the vehicle velocity, the distance, etc., for each vehicle.

According to the method for discriminating the vehicle delay phenomenon according to an exemplary embodiment of the present disclosure, there is the margin of the interval between the vehicle and the first front vehicle and the vehicle velocity of the vehicle is sufficient enough to pass the crosswalk. However, in response to determining that the vehicle may not pass the crosswalk due to deceleration of the front vehicles such as the second front vehicle, the third front vehicle, the fourth front vehicle, etc., may be driven at a low velocity, or stopped due to various environmental factors or the vehicle delay within the crosswalk passing distance range (including the clearance distance), the autonomous vehicle may be decelerated using only the regenerative braking to stop while maintaining the safety distance from the first front vehicle or stop on the crosswalk stop line. In particular, when surrounding vehicles interrupt by a change of the traffic lane while decelerating using only the regenerative braking up to the crosswalk stop line and the safety distance is threatened, the safety distance may be secured by simultaneously operating the friction braking (step S424).

Meanwhile, FIG. 5 is a schematic view for describing a method for discriminating front vehicles on the same traffic lane according to an exemplary embodiment of the present disclosure. Referring to FIG. 5, a route 502 of a road on which the vehicle is driven may be first determined using navigation information and a driving traffic lane may be monitored using the camera mounted on the vehicle. When the route 502 on which the vehicle is driven is known through the navigation, a front vehicle on the same line as the vehicle may be monitored using a high-precision global positioning systems(GPS) 500 according to navigation route information to collect the information of the front vehicles on the route. A first vehicle in front of the vehicle may be detecting only by the existing information input through the radar, the camera, etc.

The information of the first front vehicle may be collected from the information and information of the second front vehicle based on the vehicle in front of the first front vehicle may be requested to be collected with respect to the first front vehicle. In other words, the vehicle may be configured to receive the information of the second front vehicle from the first front vehicle in a chain (e.g., a chain relationship between the vehicles) to determine the condition of the second front vehicle. The information of the front vehicles such as the third front vehicle, the fourth front vehicle, etc., based on the vehicle may be transferred to a rear vehicle, and as a result, the vehicle may be configured to collect the information of the front vehicles within the crosswalk passing distance range (including the clearance distance).

A method for discriminating the front vehicles on the same traffic lane according to another exemplary embodiment of the present disclosure as a method for using IOT information in the traffic light is a method for transmitting information on various surrounding vehicles and surrounding information to a vehicle requiring information among vehicles around the traffic light by checking information of the vehicles around the traffic light by mounting the camera and the sensor on the traffic light. In the method, the vehicle does not directly collect required information by a V2V method with the vehicles, but uses the information on the IOT mounted on the traffic light.

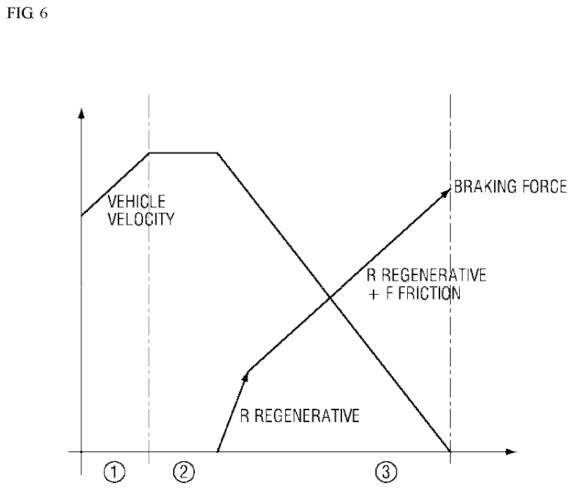

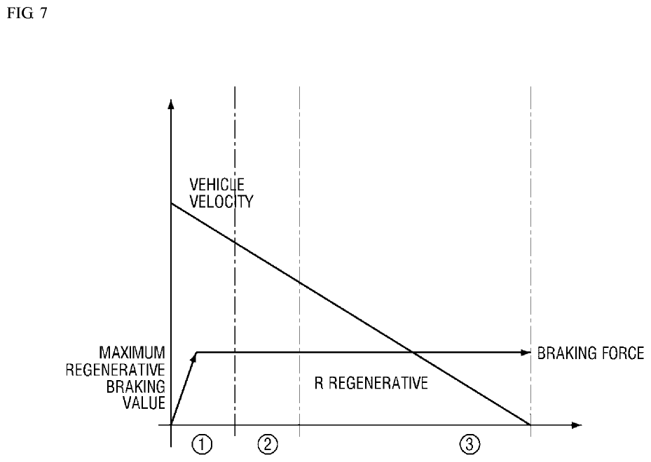

As described above, the present disclosure is a technology that uses a braking force distribution strategy of maximizing the regenerative braking and minimizing the friction braking by preemptively starting braking by determining the vehicle delay phenomenon of the front vehicles. In this regard, FIG. 6 is a graph showing a vehicle velocity and braking force distribution based on a distance from a first front vehicle when a braking force distribution strategy in the related art is applied and FIG. 7 is a graph showing a vehicle velocity and braking force distribution based on a distance from a first front vehicle when a braking force distribution strategy according to an exemplary embodiment of the present disclosure is applied.

Through FIGS. 6 and 7, the interval between the vehicle and the first front vehicle may be substantial or sufficient (e.g., greater than a predetermined distance), but when the first front vehicle or the vehicle may not pass the crosswalk due to the bumper-to-bumper scenario of the front vehicles such as the second front vehicle, the third front vehicle, the fourth front vehicle, etc., (i.e., due to the vehicle delay phenomenon), a difference between the related art and the present disclosure may be detected. In FIG. 6, section \textcircled{1} as a section in which the interval between the vehicle and the first front vehicle is sufficient indicates a case where an interval between several front vehicles is insufficient or several front vehicles are braked (i.e., vehicle delay), section \textcircled{2} is a section where the interval between the vehicle and the first front vehicle is maintained, and section \textcircled{3} is a section in which the distance between the vehicle and the first front vehicle is reduced.

In the braking force distribution strategy in the related art illustrated in FIG. 6, there is a problem in that for example, when the fourth front vehicle is decelerated while the first front vehicle is driven at a constant velocity, the deceleration gradually increases to the second front vehicle and the first front vehicle from the third front vehicle and the vehicle should be decelerated at a greater deceleration. In other words, as illustrated in FIG. 6, since the braking is not started in sections \textcircled{1} and \textcircled{2} and then the braking is started in section \textcircled{3}, friction braking force (e.g., sudden braking) (F_{friction}) is added to regenerative braking force (R_{regenration}) to brake the vehicle at the greater deceleration.

Contrary to this, in the case of the braking force distribution strategy according to the present disclosure illustrated in FIG. 7, since the vehicle velocities of several front vehicles and whether several front vehicles are decelerated are determined in advance to estimate the bumper-to-bumper (e.g., vehicle delay) unlike the related art, when the vehicle delay phenomenon is estimated, braking may be performed only by the regenerative braking force (R_{regenration}) by starting the braking in advance, i.e., in section \textcircled{1}.

Although the present disclosure has been described in detail through the representative exemplary embodiment hereinabove, it will be appreciated by those skilled in the art that various modifications of the exemplary embodiment of the present disclosure can be made without departing from the scope of the present disclosure. Therefore, the scope of the present disclosure should not be determined to be limited to the exemplary embodiment and should be defined by appended claims to be described below and all changed or modified forms derived from equivalent concepts to the appended claims.

What is claimed is:

1. A system for controlling an operation of an autonomous vehicle, comprising:
an information input unit configured to receive information regarding front vehicles of the autonomous vehicle and surrounding traffic information;
an autonomous controller configured to estimate a traffic flow of the front vehicles and a time when a traffic light color is changed from a signal received from the information input unit and calculate a maximum vehicle velocity at which the autonomous vehicle is capable of crossing the traffic light while securing a safety distance from the front vehicle by regenerative braking force to generate an acceleration/deceleration control signal for adjusting a driving velocity; and
a braking unit configured to perform braking by distributing regenerative braking force and friction braking force of the autonomous vehicle according to the acceleration/deceleration control signal received from the autonomous controller.

2. The system of claim 1, wherein the information input unit is configured to receive information using at least one of Internet Of Things (IOT), Vehicle-to-Vehicle (V2V), a radar, a LiDAR, an ultrasonic sensor, a camera, and a navigation.

3. The system of claim 1, wherein the autonomous controller is configured to collect information regarding front vehicles driven on the same traffic lane as the autonomous vehicle from the information input unit to determine a vehicle delay phenomenon.

4. The system of claim 1, wherein the autonomous controller is configured to collect information regarding front vehicles driven on the same traffic lane as the autonomous vehicle from information regarding the IOT in the traffic light to determine the vehicle delay phenomenon.

5. The system of claim 1, wherein the braking unit is configured to calculate a deceleration according to the maximum vehicle velocity by considering total braking force of the regenerative braking force and the friction braking force to distribute the regenerative braking force and the friction braking force of the autonomous vehicle.

6. A method for controlling an operation of an autonomous vehicle, comprising:
receiving, by a controller, information regarding front vehicles and surrounding traffic information in the autonomous vehicle;
estimating, by the controller, a traffic flow of the front vehicles and a time when a traffic light color is changed through the input information and calculating a maximum vehicle velocity at which the autonomous vehicle is capable of crossing the traffic light while securing a safety distance from the front vehicle by regenerative braking force to generate an acceleration/deceleration control signal for adjusting a driving velocity; and
performing, by the controller, braking by distributing regenerative braking force and friction braking force of the autonomous vehicle according to the acceleration/deceleration control signal.

7. The method of claim 6, wherein in the receiving of the information, information is received using at least one of Internet Of Things (IOT), Vehicle-to-Vehicle (V2V), a radar, a LiDAR, an ultrasonic sensor, a camera, and a navigation of the autonomous vehicle.

8. The method of claim 6, wherein in the generating of the acceleration/deceleration control signal, information regarding front vehicles driven on the same traffic lane as the autonomous vehicle is collected from the input information to determine the vehicle delay phenomenon.

9. The method of claim 6, wherein in the generating of the acceleration/deceleration control signal, information regarding front vehicles driven on the same traffic lane as the autonomous vehicle is collected from the IOT information regarding the traffic light to determine the vehicle delay phenomenon.

10. The method of claim 6, wherein in the performing of the braking, a deceleration according to the maximum vehicle velocity is calculated by considering total braking force of the regenerative braking force and the friction braking force to distribute the regenerative braking force and the friction braking force of the autonomous vehicle.
